(19) United States
(12) Patent Application Publication
(10) Pub. No.: US 2010/0326366 A1
(43) Pub. Date: Dec. 30, 2010

(54) TREAD MILL

(75) Inventor: Hong Jae Park, Seoul (KR)

Correspondence Address: CHRISTOPHER PAUL MITCHELL, 888 16TH ST., NW, SUITE 800, WASHINGTON, DC, 20006, US

(73) Assignees: Hong Jae PARK, Seoul (KR); Sang Hyun LIM, (KR)

(21) Appl. No.: 12/677,099

(22) PCT Filed: Sep. 8, 2008
(86) PCT No.: PCT/KR08/05288

§ 371 Date: Mar. 8, 2010

(30) Foreign Application Priority Data
Sep. 6, 2007 (KR) 10-2007-0090639

(51) Int. Cl. A01K 15/02; A01K 15/04

(52) U.S. Cl. 119/700; 119/728

(57) ABSTRACT

A tread mill is disclosed. The tread mill includes a lower frame to which a belt track rotated by a motor is mounted, a pair of support frames erected on an end of the lower frame in such a way as to be spaced apart from each other, and a hand rail attached to each of the support frames. The tread mill includes a harness unit for supporting a body of a pet, and a support unit removably coupled to the hand rail to support the harness unit such that the pet remains on the belt track. Such a construction allows a person or a pet to exercise.

### TECHNICAL FIELD

The present invention relates, in general, to a tread mill and, more particularly, to a tread mill which allows a person or a pet to exercise.

### BACKGROUND ART

Generally, a tread mill is an exercise machine including a belt track which is continuously rotated by a pair of rotating shafts which are spaced apart from each other by a predetermined interval. A user walks or runs on the belt track. The tread mill allows the user to exercise regardless of location.

Recently, as single tribes, old persons who live alone, and families having no child have increased, a pet consoles the lonely life of people, for example, a pet dog serves as a surrogate family member. Until now, in order to maintain the pet dog's health, the owner of the pet dog causes the pet dog to exercise in the open air. However, currently, pollution caused by pet dogs becomes an object of public concern, so that restrictions on the outdoor activity of pet dogs have become strengthened. Thus, the owner of the pet dog must make the pet dog exercise even in the house so as to preserve the pet dog's good health.

Currently, all over the world, a great number of pet dogs grow corpulent through lack of exercise. Due to the corpulence, the pet dogs suffer from diseases including arthritis, lung disorders, diabetes, fatty liver, and dermatitis.

In order to solve the health problem, a tread mill for pet dogs has come onto the market to let pet dogs exercise indoors. The construction and characteristics of the tread mill for pet dogs will be described below. The tread mill is constructed to let a pet dog exercise in the state where only the front portion of the body of the pet dog is secured to the tread mill via a dog collar which fits around the neck. Due to the size of a product, the tread mill is not suitable for exercising a large dog but may be used to exercise only a small dog.

The conventional tread mill for pet dogs is problematic in that it is difficult for a pet dog to run on a moving belt track of the tread mill in a stable posture, because only the front portion of the body of the pet dog is secured to the tread mill. That is, during running, the body may be distorted and slip off from or roll down the tread mill. Thus, while the pet dog practices running, the owner of the pet dog stands by the side of the pet dog, thus protecting the pet dog and encouraging the pet dog to continue running. In order to obtain the benefits of exercise from using the tread mill for pet dogs, the pet dog must continue running for 30 minutes or more. However, this is difficult for both the owner of the pet dog and the pet dog.

Recently, in order to solve the problem, a new tread mill for pet dogs was developed in the USA. That is, panels are mounted to both sides of the tread mill for pet dogs and come into close contact with a pet dog, thus preventing the body of the pet dog from being distorted during running, and forcing the pet dog to continue running. However, the forcible running practice may become a bad memory for the pet dog, so that the pet dog may avoid running in the future.

Further, the original purpose of the dog collar for pet dogs is to cure bad habits of a pet dog or to teach the notion of prohibition to the pet dog by pulling the dog collar when the pet dog is being trained. However, such an action may threaten the life of the pet dog. Thus, a harness used for training the pet dog to cure the dog's bad habits is unsuitable for use during exercise of the pet dog.

Therefore, a tread mill for pet dogs must be urgently developed, which allows a pet dog to safely and comfortably exercise on the tread mill, straight away and without additional training, to maintain the health of the pet dog.

Thereby, the applicant of this invention has developed a tread mill which allows a person or a pet to exercise.

### DISCLOSURE OF INVENTION

### Technical Problem

Accordingly, the present invention has been made keeping in mind the above problems occurring in the prior art, and an object of the present invention is to provide a tread mill which allows a person or a pet to exercise.

Another object of the present invention is to provide a tread mill which is adjustable to correspond to the size of a pet which is to be exercised.

### Technical Solution

In order to accomplish the above objects, the present invention provides a tread mill having a lower frame to which a belt track rotated by a motor is mounted, a pair of support frames erected on an end of the lower frame in such a way as to be spaced apart from each other, and a hand rail attached to each of the support frames, the tread mill including a harness unit for supporting a body of a pet, and a support unit removably coupled to the hand rail to support the harness unit such that the pet remains on the belt track.

The support unit includes a coupler which is removably coupled to an end of the hand rail, a support bar which is coupled to an end of the coupler in such a way as to extend a length of the hand rail, and a hanger frame which is provided to be perpendicular to the support bar and supports the harness unit such that it is spaced apart from the belt track.

The tread mill further includes a collet which has a plurality of jaws divided by a plurality of slots and is coupled to ends of both the coupler and the support bar, and a fastening nut which is coupled to the outer circumference of the collet in a threaded manner, thus fastening the collet to the coupler and the support bar. Thereby, the coupler can be conveniently coupled to the support bar.

Further, according to another aspect, the tread further includes a plurality of locking holes which are formed in the outer circumference of the coupler, and a plurality of balls which are retractably provided on an outer circumference of the support bar and locked to or unlocked from the corresponding locking holes of the coupler. Thereby, the coupler can be conveniently coupled to the support bar.

The hanger frame includes a plurality of mounting holes which supports the harness unit such that a mounting height of the harness unit is adjustable relative to the belt track, in order to correspond to the size of a pet which is to be exercised.

The above and other objects, features and advantages of the present invention will be more clearly understood from the following detailed description taken in conjunction with the accompanying drawings. Here, the terminologies or words used in the description and the claims of the present invention should not be interpreted as being limited merely to common and dictionary meanings, but should be interpreted based on the meanings and concepts of the invention in keeping with the scope of the invention on the basis of the principle that the inventor can appropriately define the terms in order to describe the invention in the best way.

### ADVANTAGEOUS EFFECTS

A tread mill according to the present invention is advantageous in that a person or a pet can exercise. Further, the tread mill is adjustable to correspond to the size of a pet which is to be exercised.

### BRIEF DESCRIPTION OF THE DRAWINGS

FIG. 1 is a perspective view illustrating a tread mill according to the present invention,

FIG. 2 is an exploded perspective view illustrating important parts of FIG. 1,

FIG. 3 is an exploded perspective view illustrating a coupling structure of hand rails with a support unit of FIG. 1,

FIG. 4 is a sectional view illustrating important parts of FIG. 3,

FIG. 5 is an exploded perspective view illustrating a coupling structure of hand rails with a support unit of a tread mill according to another embodiment of the present invention,

FIG. 6 is a sectional view illustrating important parts of FIG. 5, and

FIGS. 7 to 9 are views illustrating the use of the tread mill according to the present invention.

### DESCRIPTION OF REFERENCE CHARACTERS OF IMPORTANT PARTS

11: lower frame
15: belt track
17: support frame
25: hand rail
31: harness unit
33: foreleg fitting harness
35: belly harness
41: lower portion support harness
45: support cord
51: support unit
53: coupler
61: support bar
65: hanger frame
67: mounting hole
71: collet
71a: jaw
71b: slot
75: fastening nut
81: locking hole
85: ball

### MODE FOR THE INVENTION

Hereinafter, a tread mill according to the present invention will be described with reference to the accompanying drawings.

Reference now should be made to the drawings, in which the same reference numerals are used throughout the different drawings to designate the same or similar components. For the clarity of description, known functions and constructions relating to the present invention will be omitted herein.

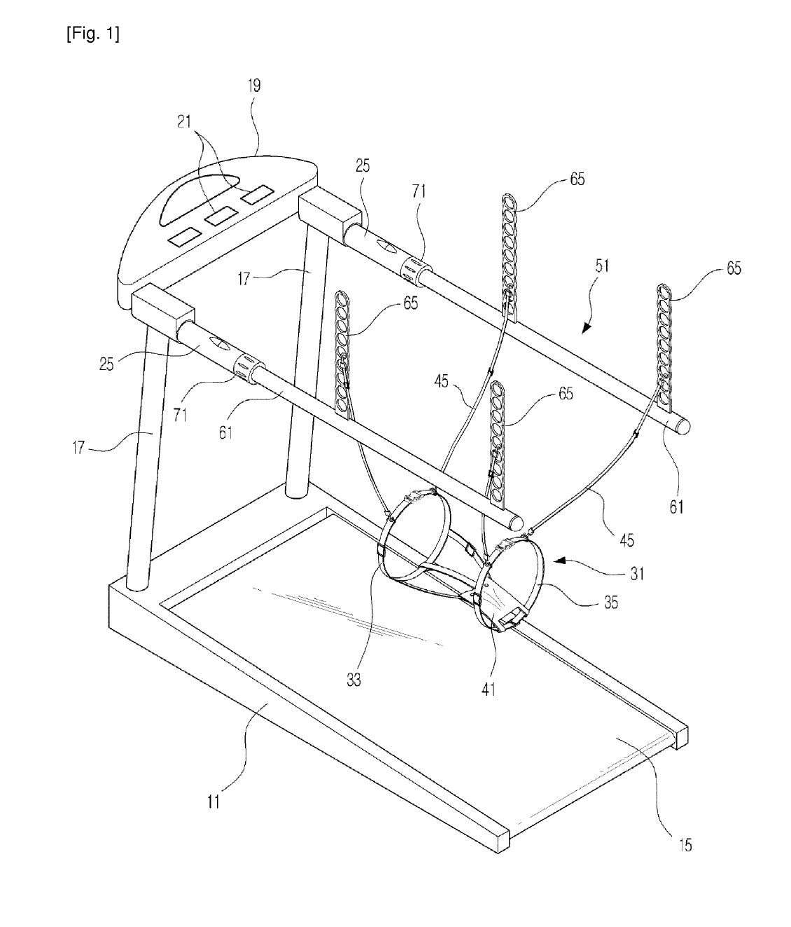

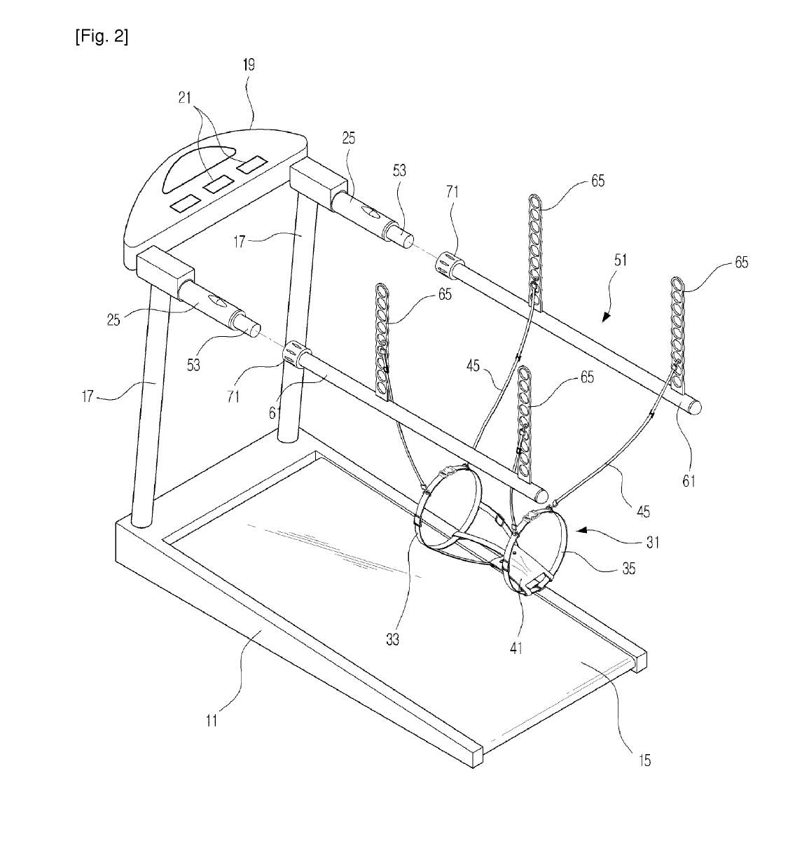

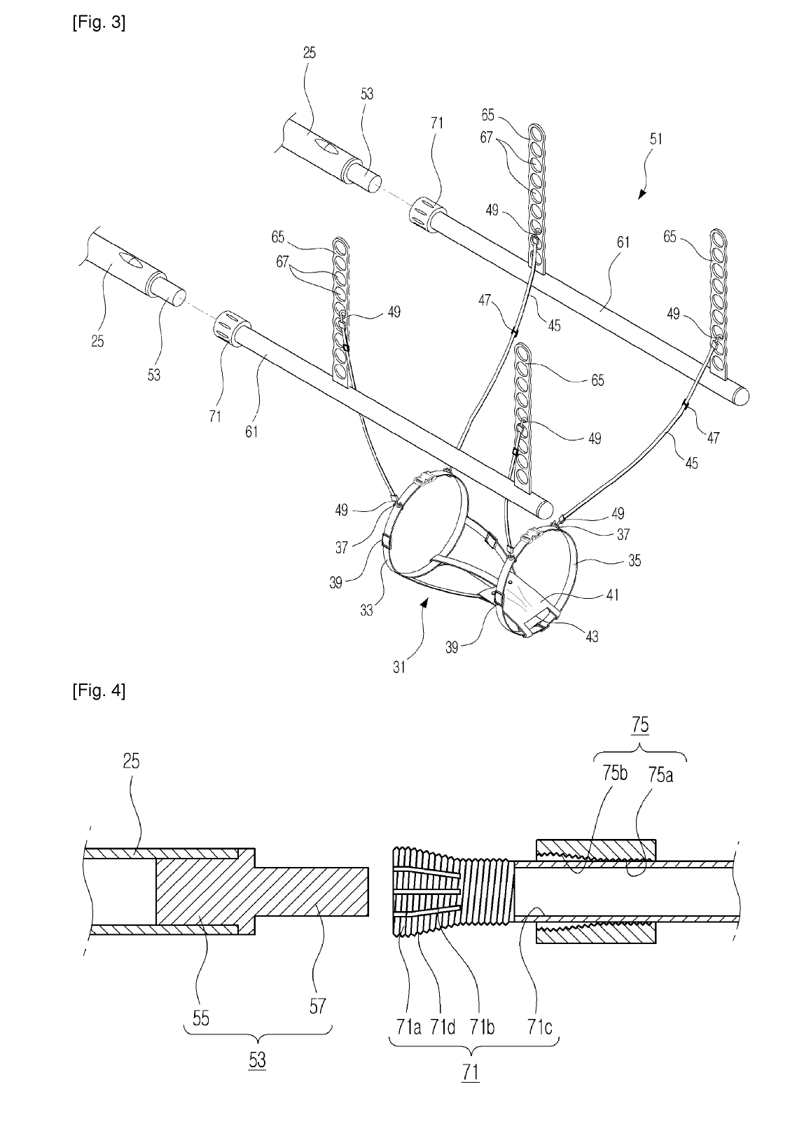

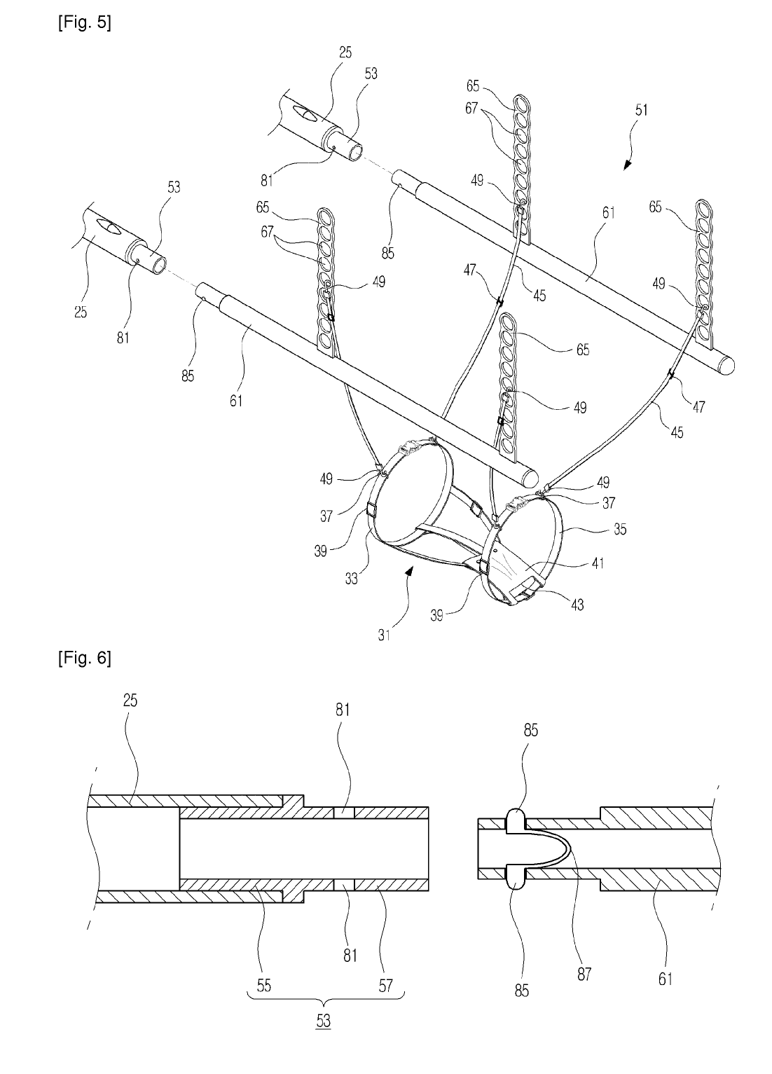

FIGS. 1 to 4 illustrate a tread mill according to the present invention.

As shown in the drawings, the tread mill according to the present invention includes a lower frame 11 to which a belt track 15 is mounted, the belt track being rotated by a motor (not shown). A pair of support frames 17 is erected up on one end of the lower frame 11 in such a way as to be spaced apart from each other. Hand rails 25 are attached to the corresponding support frames 17 such that a user may grasp the hand rails during exercise. The tread mill also includes a harness unit 31 for supporting the body of a pet. A support unit 51 functions to support the harness unit 31 and is removably coupled to the hand rails 25.

The lower frame 11 and the support frames 17 define the appearance of the external frame of the tread mill.

A control panel 19 is mounted to the upper portion of the support frames 17 so that an exerciser may be aware of the conditions of exercise and control the quantity of exercise. The control panel 19 is provided with a display part which displays the speed, moving distance, calories consumed, course, and others, and a plurality of manipulating buttons 21, including a start button, a speed control button, and a sudden stop button.

According to this embodiment, each hand rail 25 has the shape of a hollow pipe. A cap (not shown) is removably provided on an end of each hand rail 25, thus preventing impurities from entering the hand rail 25.

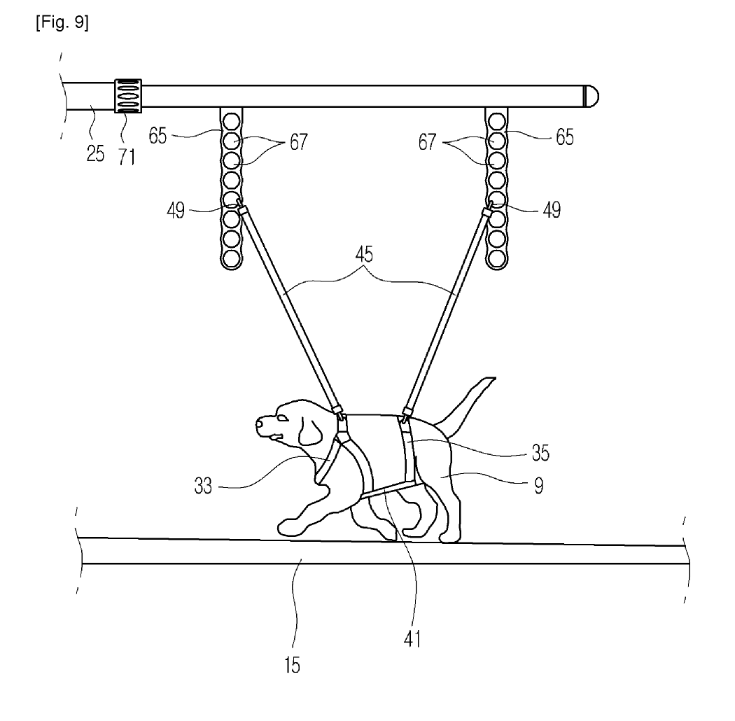

The harness unit 31 includes a foreleg fitting harness 33, a belly harness 35, a lower portion support harness 41, and support cords 45. The forelegs of a pet dog 9 (see FIG. 7) are fitted into the foreleg fitting harness, so that the foreleg fitting harness supports the front portion of the body of the pet dog 9. The belly harness supports the rear portion of the body of the pet dog 9. The lower portion support harness removably couples the foreleg fitting harness 33 with the belly harness 35, and supports the lower portion of the body of the pet dog 9. The foreleg fitting harness 33, the belly harness 35, and the lower portion support harness 41 are supported via the support cords to hanger frames 65 of the support unit 51 which will be described later.

Each of the foreleg fitting harness 33 and the belly harness 35 is provided with a hook connection ring 37 to which a hook 49 of each support cord 45 is connected, and a length adjusting part 39.

The lower portion support harness 41 is removably connected to the foreleg fitting harness 33 and the belly harness 35 through a fitting structure. That is, as shown in the drawings, the foreleg fitting harness 33 is removably connected to one end of the lower portion support harness 41 via a spring hook or a Velcro fastener, so that the foreleg fitting harness 33 is fastened to the lower portion support harness. Further, a groove 43 is formed in the opposite end of the lower portion support harness, so that the length of the belly harness 35 exposed through the groove 43 is adjustable.

Each support cord 45 is provided with a length adjusting part 47, and hooks 49 are provided on the opposite ends of the support cord. The hook 49 which is provided on one end of the support cord 45 is connected to an associated mounting hole 67 of each hanger frame 65 of the support unit, and the hook 49 which is provided on the other end of the support rod is connected to an associated hook connection ring 37 of the foreleg fitting harness 33 or the belly harness 35.

Preferably, the harness unit 31 is supported by the hanger frames 65 in such a way that the harness unit is spaced apart from the belt track 15.

The support unit 51 supports the harness unit 31 such that the pet dog is placed on the belt track 15, and is removably coupled to the hand rails 25.

The support unit 51 includes a coupler 53 which is removably mounted to an end of each hand rail 25, a support bar 61 which is connected to the end of the coupler 53 in such a way as to extend from the hand rail 25, and the hanger frames 65 which are provided to be perpendicular to each support bar 61 and support the harness unit 31 in such a way that the harness unit is spaced apart from the belt track 15.

The coupler 53 includes a rail coupling part 55 which is removably fitted into each hand rail 25, and a bar coupling part 57 which extends longitudinally from one end of the rail coupling part 55 in such a way as to protrude from one end of the hand rail 25, so that the end of each support bar 61 is coupled to the bar coupling part.

Each support bar 61 has the shape of a hollow pipe of a predetermined length, and is coupled to the bar coupling part 57 of the coupler 53 to extend the length of the hand rail 25.

A pair of hanger frames 65 is provided on the outer circumference of each support bar 61 in such a way as to be spaced apart from each other in the longitudinal direction of the support bar. Each hanger frame 65 has the shape of a plate, and is mounted to the corresponding support bar 61 in such a way as to be perpendicular to the longitudinal direction of the support bar 61. A plurality of mounting holes 67 is formed in each hanger frame 65 to support the harness unit 31. The mounting holes 67 are formed at regular intervals in each hanger frame 65 in the longitudinal direction thereof. The hook 49 provided on each support cord 45 of the harness unit 31 is connected to an associated mounting hole 67. By connecting the hook 49 of each support cord 45 to a selected mounting hole 67 of each hanger frame 65, the mounting height of the harness unit 31 from the belt track 15 can be adjusted to correspond to the size of the pet dog which is to be exercised.

Meanwhile, the tread mill according to the present invention includes a collet 71 which is connected to the ends of both the coupler 53 and the support bar 61, and a fastening nut 75 which fastens the collet 71 to both the coupler 53 and the support bar 61.

The collet 71 has a plurality of jaws 71a which are divided by a plurality of slots 71b. The jaws 71a are formed to be inclined. The collet 71 has a hollow part 71c into which the end of the coupler 53 is inserted, with a threaded part 71d provided on the outer circumference of the collet.

The fastening nut 75 includes a threaded part 75a and a tapered part 75b. The threaded part is formed in the inner circumference of the fastening nut. The tapered part is provided in part of the inner circumference of the fastening nut to compress the plurality of jaws 71a.

Thus, after one end of each collet 71 is coupled to the end of the corresponding support bar 61, the end of the bar coupling part 57 of the coupler 53 is inserted into the hollow part 71c which is provided on the other end of the collet 71, so that the position of the coupler 53 is adjusted. Subsequently, the threaded part 75a of the fastening nut 75 engages with the threaded part 71d of the collet 71. At this time, the jaws 71a of the collet 71 are tightened, so that the inserted coupler 53 is secured to a predetermined position and thereby the coupler 53 and the support bar 61 can be conveniently coupled to each other.

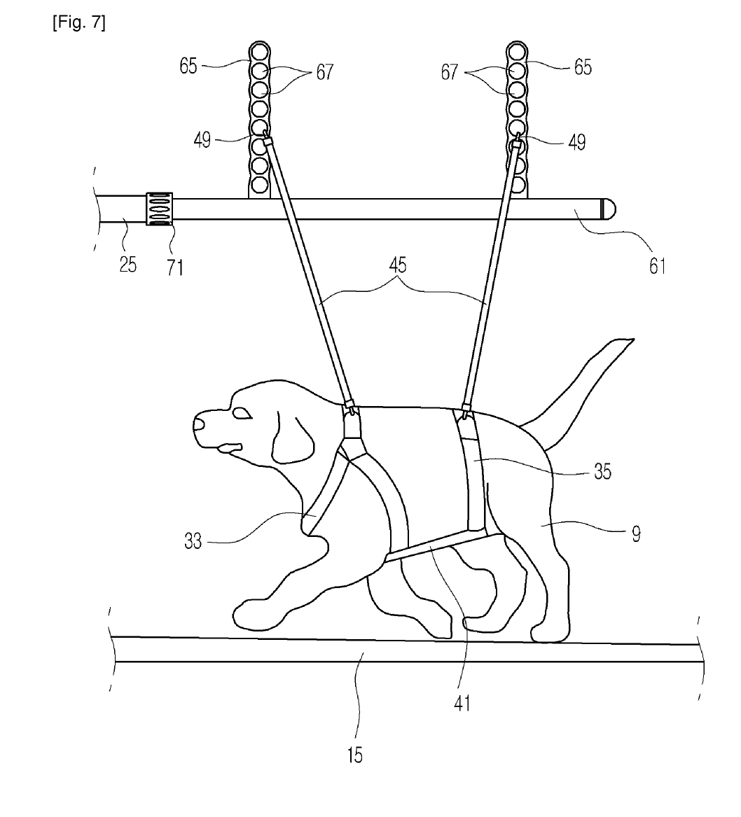

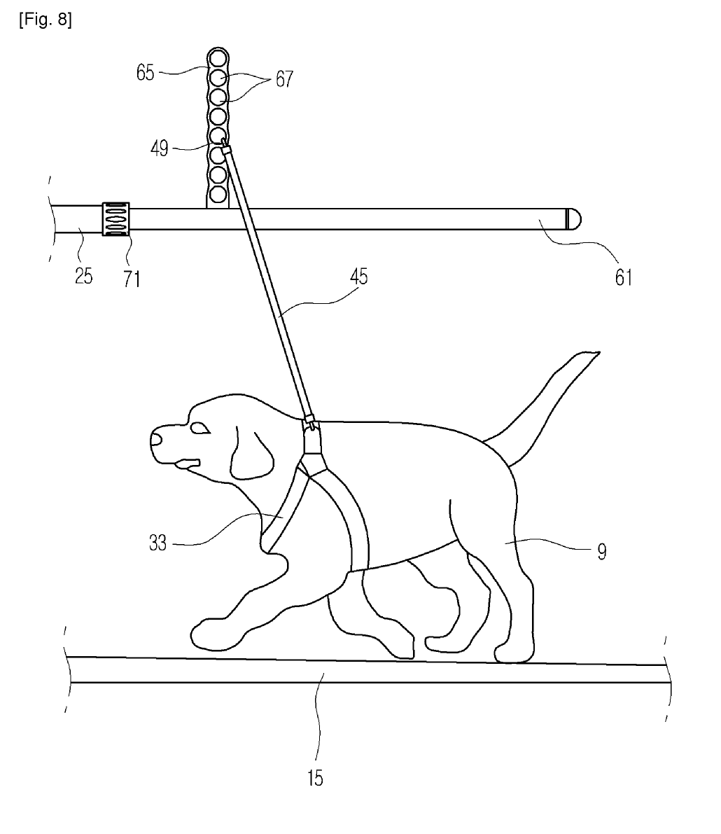

Meanwhile, FIGS. 5 and 6 illustrate the coupling structure of hand rails 25 with a support unit 51 of a tread mill according to another embodiment of the present invention. A pair of locking holes 81 is formed in the outer circumference of the coupler 53, and a pair of balls 85 is retractably provided on the outer circumference of the support bar 61 to be locked to or unlocked from the locking holes 81 of the coupler 53.

The pair of balls 85 is provided on a spring plate 87 having predetermined elasticity. The spring plate 87 is mounted in the support bar 61 in such a way that the balls 85 are retracted and ejected through holes formed in the outer circumference of the support bar 61.

Thus, after the end of the support bar 61 is inserted into the bar coupling part 57 of each coupler 53, the pair of balls 85 is locked to the locking holes 81 of the bar coupling part 57 of each coupler 53, so that the coupler 53 and the support bar 61 can be conveniently coupled to each other.

Here, when the coupler 53 and the support bar 61 are coupled to each other, the position of the hanger frames 65 is adjusted in consideration of the body size of the pet dog 9 which is to be exercised. That is, as one example, when the height of the back of the pet dog 9 is 20 cm or less, the hanger frames 65 are arranged to face downwards. Meanwhile, when the height of the back of the pet dog 9 is above 20 cm, the hanger frames 65 are arranged to face upwards.

The use of the tread mill according to the present invention constructed as described above will be described below.

Hereinafter, the case wherein a large pet dog 9 whose height of the back exceeds 50 cm uses the tread mill will be described with reference to FIGS. 7 and 8.

First, the couplers 53 are mounted to ends of the corresponding hand rails 25 of the tread mill in such a way that the bar coupling parts 57 protrude from the hand rails 25.

Next, one end of each collet 71 is coupled to the end of the corresponding support bar 61 and the end of the bar coupling part 57 of each coupler 53 is inserted into the hollow part 71c provided in the other end of the collet 71, so that the position of each coupler 53 is adjusted. Thereafter, the threaded part 75a of each fastening nut 75 engages with the threaded part 71d of the corresponding collet 71, the jaws 71a of the collet 71 are tightened, so that the coupler 53 and the support bar 61 are coupled to each other. At this time, in consideration of the height of the back of a pet dog 9, each coupler 53 is coupled to the corresponding support bar 61 in such a way that the hanger frames 65 face upwards.

Thus, the pair of support bars 61 is supported by the ends of the hand rails 25.

Further, the hooks 49 of the support cords 45 are connected to the opposite mounting holes 67 of the hanger frames 65 provided on both sides of the tread mill, so that the harness unit is supported by the hanger frames 65. At this time, the hooks 49 of the support cords 45 are connected to the mounting holes 67 of the hanger frames 65 according to the height of the back of the pet dog 9.

Subsequently, the forelegs of the pet dog 9 are fitted into the foreleg fitting harness 33 and simultaneously the front portion of the body of the pet dog 9 is supported by the foreleg fitting harness. The rear portion of the body of the pet dog 9 is supported by the belly harness 35, and the lower portion of the body of the pet dog 9 is supported by the lower portion support harness 41, so that the pet dog 9 remains on the belt track 15.

Further, when the manipulating buttons 21 of the control panel 19 are manipulated to rotate the belt track 15, the pet dog 9 placed on the belt track 15 can exercise according to the rotating speed of the belt track 15.

Meanwhile, if the pet dog 9 is accustomed to exercising using the tread mill, as shown in FIG. 8, the pet dog 9 can exercise in the state where the belly harness 35 and the lower portion support harness 41 of the harness unit 31 are removed from the body of the pet dog 9.

Meanwhile, FIG. 9 illustrates the use of the tread mill according to another embodiment of the present invention. Unlike the above-mentioned embodiments, the coupler 53 is connected to the corresponding support bar 61 in such a way that the hanger frames 65 face downwards.

As described above, the body of the pet dog 9 is supported by the harness unit 31. The harness unit 31 is supported by the hanger frames 65.

Thereby, a mini pet dog 9 whose height of the back is 20 cm or less can also exercise using the tread mill according to the present invention.

Further, when a person desires to use the tread mill according to the present invention, the support unit 51 is separated from the hand rails 25, so that he or she can conveniently use the tread mill.

As such, the support unit to which the harness unit for supporting the body of a pet is connected is attachable to and detachable from the hand rails of the conventional tread mill, so that a pet or a person can exercise on the tread mill.

Further, the plurality of mounting holes is formed in each hanger frame to support the harness unit, so that the mounting height of the harness unit relative to the belt track may be adjusted to correspond to the size of the pet which is to be exercised.

The above-mentioned embodiments illustrate the example wherein a dog was selected from among various pets as the pet which uses the tread mill according to the present invention. However, of course, a cat or other kinds of pets may use the tread mill according to the present invention.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A tread mill having a lower frame to which a belt track rotated by a motor is mounted, a pair of support frames erected on an end of the lower frame in such a way as to be spaced apart from each other, and a hand rail attached to each of the support frames, the tread mill comprising:
a harness unit for supporting a body of a pet, and a support unit removably coupled to the hand rail to support the harness unit such that the pet remains on the belt track,
the support unit comprises a coupler removably coupled to an end of the hand rail, a support bar coupled to an end of the coupler in such a way as to extend a length of the hand rail, and a hanger frame provided to be perpendicular to the support bar and supporting the harness unit so that the pet is placed on the belt track.

2. The tread mill according to claim 1, further comprising:
a collet having a plurality of jaws divided by a plurality of slots, and coupled to ends of both the coupler and the support bar; and
a fastening nut coupled to an outer circumference of the collet in a threaded manner, thus fastening the collet to the coupler and the support bar.

3. The tread mill according to claim 1, further comprising:
a plurality of locking holes formed in an outer circumference of the coupler; and
a plurality of balls retractably provided on an outer circumference of the support bar, and locked to or unlocked from the corresponding locking holes of the coupler.

4. The tread mill according to claim 1, wherein the hanger frame comprises a plurality of mounting holes which supports the harness unit such that a mounting height of the harness unit is adjustable relative to the belt track.

5. The tread mill according to claim 2, wherein the hanger frame comprises a plurality of mounting holes which supports the harness unit such that a mounting height of the harness unit is adjustable relative to the belt track.

6. The tread mill according to claim 3, wherein the hanger frame comprises a plurality of mounting holes which supports the harness unit such that a mounting height of the harness unit is adjustable relative, to the belt track.
